(19) United States
(12) Patent Application Publication
(10) Pub. No.: US 2012/0166012 A1
(43) Pub. Date: Jun. 28, 2012

(54) POWER SUPPLY CONTROL METHOD, A POWER MANGEMENT METHOD, AND A POWER SYSTEM

(75) Inventors: So Yeon LEE, Daejeon-si (KR); Hyun Jeong YUN, Daejeon-si (KR); Sang Joon PARK, Daejeon-si (KR)

(73) Assignee: Electronics and Telecommunications Research Institute, Daejeon (KR)

(21) Appl. No.: 13/335,718

(22) Filed: Dec. 22, 2011

(30) Foreign Application Priority Data
Dec. 22, 2010 (KR) 10-2010-0132059

(51) Int. Cl. G06F 1/26

(52) U.S. Cl. 700/297

(57) ABSTRACT

A power supply control method, a power management method, and a power system are provided. The power supply control method according to an aspect of the present invention includes: receiving information on a position and a battery of a vehicle; and supplying power to a charging station in the predetermined range of the position of the vehicle to be able to charge the battery of the vehicle based on the information on the position and the battery.

### CROSS-REFERENCE TO RELATED APPLICATIONS

This application claims the benefit of priority of Korean Patent Application No. 10-2010-0132059 filed on Dec. 22, 2010, all of which are incorporated by reference in their entirety herein.

### BACKGROUND OF THE INVENTION

1. Field of the Invention

The present invention relates to a power supply control method, a power management method, and a power system, and more particularly, to a power supply control method, a power management method, and a power system capable of controlling supply and demand of power associated with an electric automobile in real time and bidirectionally.

2. Related Art

Due to issues of climate change and exhaustion of oil fuel that are considered as the most urgent matters all over the world, commercialization of an electric automobile has been more rapidly promoted beyond specialist's expectations. In recent years, a technology of an electric automobile has been rapidly developed by advanced countries of the production of automobiles. Therefore, there is a need to greatly change a power system of each country. Many specialists point out a charging infrastructure as the top issue for commercializing an electric automobile, which may cause the following problems in two aspects.

First, the electric automobile has highly flexible mobility(short/middle/long- distance), it is very difficult to forecast the demand for power unlike home appliances. Second, a though current power grid has been more intelligently progressed by being combined with an IT technology, however, if the current power grid fails to supply securely reserved power so as to meet the increased demand of rapid (DC; direct current) charging due to the mass propagation of the electric automobile, it may not smoothly supply power, keeping up with demand, which is highly likely to cause a great loss to a customer.

In the early stage, a telematics/ITS technology has provided vehicular multimedia services that delivers information, such as traffic guidance, emergency rescue, etc., to a car driver and entertainment services, such as Internet, movie, game, etc., to passengers, using a location information(or location area) and a wireless communication network. Presently, the telematics/ITS technology has been developed to actively secure vehicle safety and provide convenience improvement services of a driver by providing intelligent vehicle information. As the issues of vehicle safety and convenience improvement services are raised in recent, there has been developed a technology of providing various vehicle information based telematics/ITS services by collecting vehicle information that is a basis of the vehicle safety and the convenience improvement services, that is, data including vehicle conditions, such as vehicle fault code, vehicle speed, engine RPM, cooling water temperature, etc., all of which can be obtained by an engine control unit (ECU) for a vehicle. This also enables provide various convergence services, such as maintenance reservation and emergency dispatch through remote vehicle diagnosis, application of differential premium according to vehicle driving information, etc.

A smart grid is defined as a power-IT fusion technology that uses IT to communicate power production/consumption information bidirectionally and in real time in order to optimize energy efficiency and distributes power to enable provide efficient power control and economical use, such as supply of differential quality of power, automated fault recovery, etc. The smart grid is a technology suggested to supplement several problems occurring in the existing power system and more intelligently and efficiently operate a power system so as to cope with an increase in new power demand, such as promoting use of new renewable energy, development of electrical transportation, etc. The development process of the smart grid has been progressed in order of a process of increasing efficiency of a supply network, a process of increasing demand efficiency, a process of increasing a new renewable energy source, a process of implementing a distributed control system, and a process of freely implementing a new business mode. In particular, popularization of electrical transportation is closely associated with the final process.

An electrotransport system, that is, an electric automobile having mobility using electric energy, not using existing gasoline has driving performance of about 150 to 200 km with one-time charge, which implies that the charging is continuously made according to situations and conditions. Unlike power demanding electronic products for home/building, the electric automobile has very high mobility in terms of characteristics, such that it is difficult to forecast demand for charging. It is impossible to continuously increase power facilities so as to meet a power peak. In addition, when reserved power is insufficient in the corresponding area, there may lead to a case where a desired amount of electricity is not supplied in time. This difficulty may serve as fatal disadvantages in popularizing the electric automobile and obstacles in achieving a target pursued by the smart grid in viewpoint of the power system.

### SUMMARY OF THE INVENTION

This invention is to let charging stations reserve power previously according to the estimated power demand in real time by monitoring charging status of a battery in an electric automobile, which is located in nearby, pass-thru or requesting the reservation for charging by telematics.

Further, when a battery state is degraded below specific conditions, a vehicle terminal includes a two-way electric automobile telematics technology that informs this state through a head unit or a user portable device in a vehicle and is connected with a navigation map to be able to share information, such as location information, charging standby time, possibility of charging at charging stations in the predetermined range of an area in which the vehicle terminal is currently located, etc., in real time.

In an aspect, a power supply control method is provided. The power supply control method includes: receiving information on a location and a battery of a vehicle; and supplying power to charging stations in the predetermined range of the location of the vehicle to be able to charge the battery of the vehicle based on the information on the location and the battery.

In another aspect, a power management method is provided. The power management method includes: supplying power from a power center according to holding power amount and a battery state of a vehicle; and transmitting at least one of location information, information on estimated standby time, and charging price information of the charging stations and power amount held by the charging stations to the vehicle.

In another aspect, a power system is provided. The power system includes: a vehicle terminal transmitting information on a battery; and a power center server supplying power to charging stations in the predetermined range of the location of the vehicle to be able to charge the battery of the vehicle based on information on the battery and information on the location of the vehicle terminal.

### BRIEF DESCRIPTION OF THE DRAWINGS

FIG. 1 is a diagram showing an entire power center, charging facilities of an electric automobile, and a system in a vehicle showing the concept of the present invention;

FIG. 2 is a flow chart for describing a power supply control method, a power management method, and a power system according to an exemplary embodiment of the present invention;

FIG. 3 is an exemplified diagram showing information on a vehicle transmitted to the power center server;

FIG. 4 is an exemplified diagram showing a 3GPP based mobile network architecture;

FIG. 5 is a flow chart showing a procedure of attaching a vehicle terminal to a network;

FIG. 6 is a flow chart showing a procedure of updating a tracking area;

FIG. 7 is a flow chart showing a procedure of transmitting information on the location of the vehicle to the power center server;

FIG. 8 is a flow chart showing another procedure of transmitting information on the location of the vehicle to the power center server; and

FIG. 9 is a flow chart for describing a power supply control method and a power system according to another exemplary embodiment of the present invention.

### DESCRIPTION OF EXEMPLARY EMBODIMENTS

Advantages and features of the present invention and methods to achieve them will be elucidated from exemplary embodiments described below in detail with reference to the accompanying drawings. However, the present invention is not limited to exemplary embodiment disclosed herein but will be implemented in various forms. The exemplary embodiments make disclosure of the present invention thorough and are provided so that those skilled in the art can easily understand the scope of the present invention. Therefore, the present invention will be defined by the scope of the appended claims. Meanwhile, terms used in the present invention are to explain exemplary embodiments rather than limiting the present invention. Unless explicitly described to the contrary, a singular form includes a plural form in the present specification. “Comprises” and “comprising” used herein does not exclude the existence or addition of one or more other components, steps, operations and/or elements other than stated components, steps, operations, and/or elements.

When there is a need to determine battery residual amount of a vehicle and charge a battery, an exemplary embodiment of the present invention transmits present location and battery status information of a vehicle to a power management server and charges the battery. The power center server prepares reserved power in charging stations in the vicinity of(in the predetermined range of) the location of the vehicle and informs a vehicle of additional information such as status information of a station on possibility of charging, price information, etc., to control supply and demand of power associated with a vehicle in real time and bidirectional.

Hereinafter, a power supply control method, a power management method, and a power system according to exemplary embodiments of the present invention will be described with reference to the accompanying drawings.

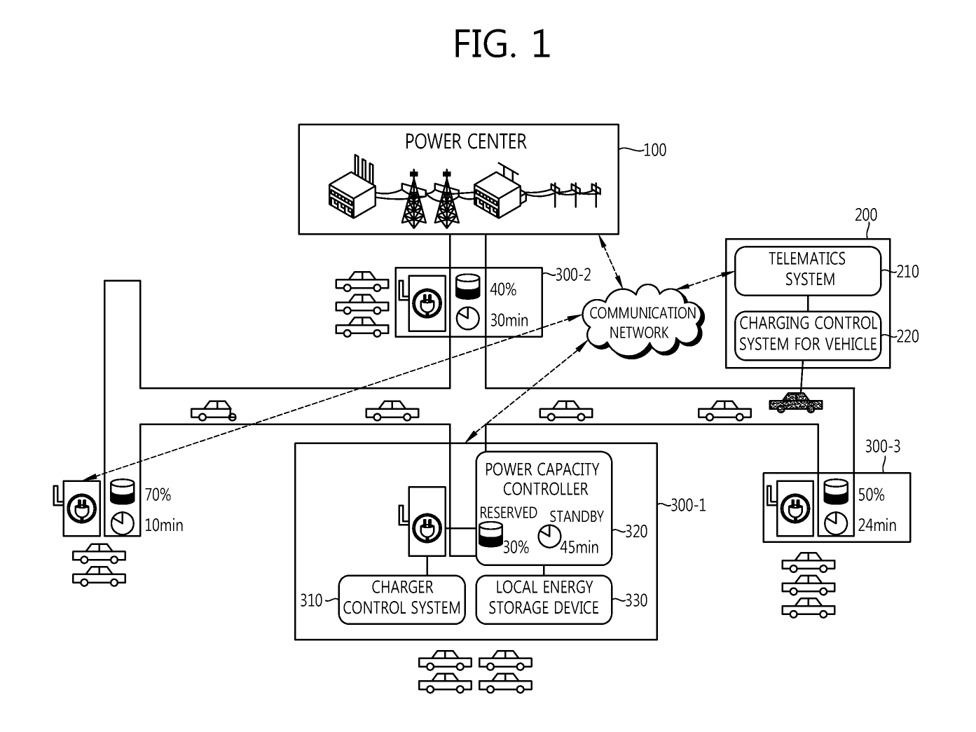

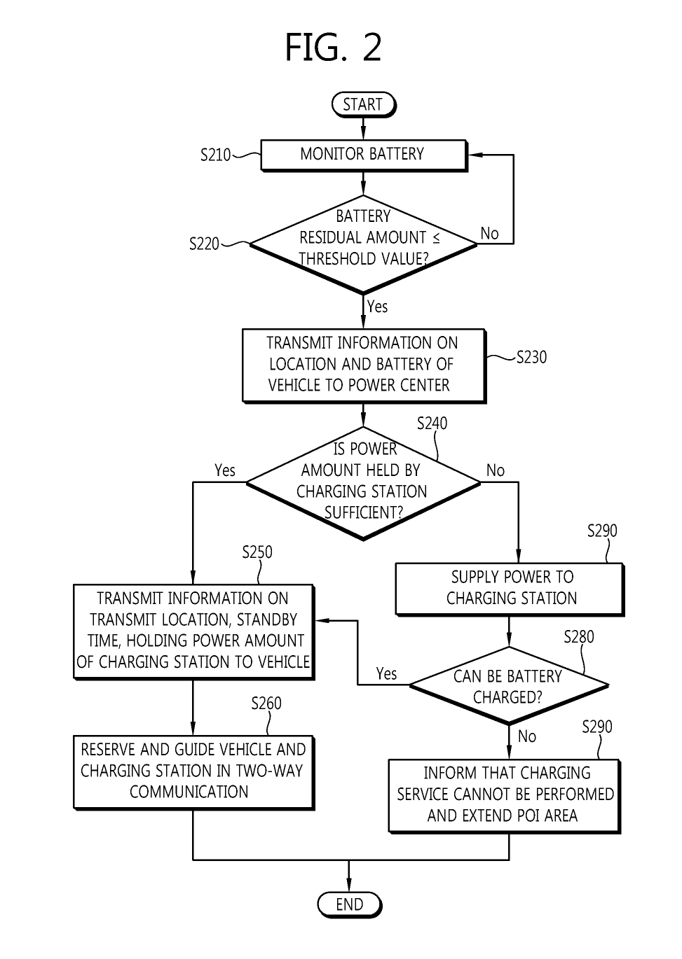

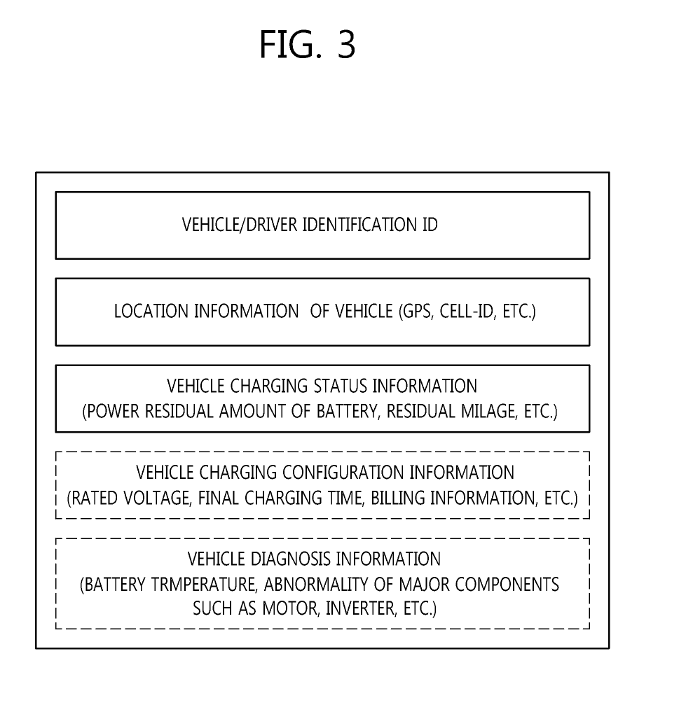

First, a power supply control method, a power management method, and a power system according to an exemplary embodiment of the present invention will be described with reference to FIGS. 1 to 3. FIG. 1 is a diagram showing an entire power center, charging facilities of an electric automobile, and a system in a vehicle showing a concept of the present invention, FIG. 2 is a flow chart for describing a power supply control method, a power management method, and a power system according to an exemplary embodiment of the present invention, and FIG. 3 is an exemplified diagram showing information on a vehicle transmitted to the power center server.

Referring to FIG. 1, a power system according to an exemplary embodiment of the present invention includes a power center, vehicles, and charging stations. In this case, a vehicle, which is an electric automobile, includes a vehicle terminal including a telematics unit and a charging control unit for a vehicle. The charging station includes a charging control unit, a power capacity controller, and a local energy storage device.

A driver or a charging control unit 220 for a vehicle is determined whether there is a need to charge a battery by continuously monitoring a charging state of a battery in a vehicle using the charging control unit 220 for a vehicle during the driving of the vehicle.

When the charging of the battery is needed, the information on the battery and the information on the location of the electric automobile are transmitted to charging stations 300_1, 300_2, and 300_3 in vicinity of the location of the electric automobile.

Further, two-way communication is established between a telematics unit 210 of the electric automobile requiring the charging and a power capacity controller 320 of the charging stations and information such as reserved power amount, estimated standby time, fee in a local energy storage device 330 of the charging station is transmitted to the telematics unit 210. The driver reserves the charging in a specific charging station using the telematics unit 210 based on the information transmitted from the charging station and the charging station transmits point of interest (POI) to the electric automobile in order to guide the electric automobile to the charging station.

In this case, when the power amount held by the charging station is insufficient as compared with the required power amount requested by the vehicle, the power center previously supplies power to the corresponding charging station, such that the charging station may secure reserved power so as not to cause a problem in the supply of power when the vehicle visits the station.

Hereinafter, the power system will be described in more detail with reference to FIG. 2.

First, the vehicle terminal, for example, the charging control unit for a vehicle determines whether the residual amount of the battery is smaller than a threshold value (S220) while monitoring the battery (S210). When the residual amount of the battery is smaller than the threshold value, the vehicle terminal, for example, the telematics unit transmits the information on the location of the vehicle and the information on the battery to the power center. FIG. 3 shows in detail data transmitted to the power center by the vehicle terminal. In other words, the data transmitted to the power center by the vehicle terminal may include vehicle and driver identification ID, a location information of a vehicle, charging status information of a vehicle, charging configuration information of a vehicle, and diagnosis information of a vehicle. The charging status information of a vehicle may be power residual amount of a battery, battery temperature, residual milage, etc., and the charging configuration information of a vehicle may be rated voltage of a battery, final charging time, billing information, etc. The diagnosis information of the vehicle may be battery temperature, abnormality or not of a motor, etc.

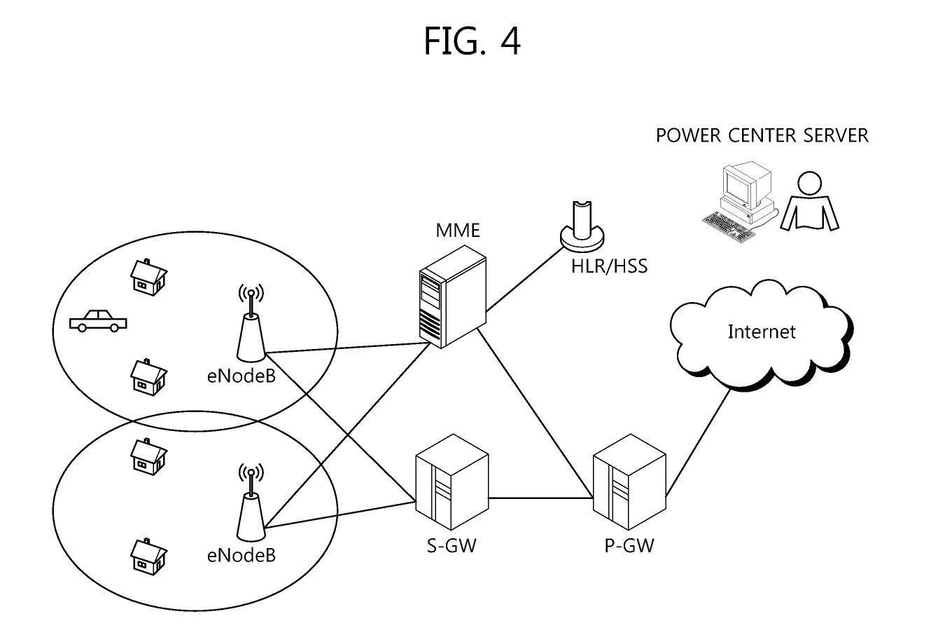

Meanwhile, the information on the battery may be transmitted by applications installed in the vehicle terminal. That is, the vehicle terminal may report the information on the battery in a user data type through a mobile communication network that is directly connected with the power center server. The information on the location of the vehicle may not be directly transmitted to the power center server but may be transmitted by various methods through the mobile communication network. The detailed examples thereof will be described below with reference to FIGS. 4 to 9.

The power center server receives the information on the location of the vehicle and the information on the battery and determines whether the power amount held by the charging station in the vicinity of the location of the vehicle is enough to charge the battery of the vehicle (S240).

In detail, when the power center server receives the information on the battery from the vehicle terminal, it may query the holding power amount to the charging stations in the vicinity of the location of the vehicle and determine whether the power amount held by the charging station is enough to charge the battery of the vehicle by comparing the holding power amount received as the queried results with the information on the received battery. Alternatively, when the power center server receives the information on the battery from the vehicle terminal, it transmits the information on the battery to the charging stations in the vicinity of the location of the vehicle to enable each charging station to determine whether there is a need to charge a battery.

When the power amount held by the charging station is enough to charge the battery of the vehicle, the power center server may transmit information on the location, standby time, and holding power amount of the corresponding charging station to the vehicle terminal (S250). Alternatively, when the power amount held by the charging station is enough to charge the battery of the vehicle, the charging stations may transmit the information on their own locations, the standby time, and the holding power amount to the vehicle terminal.

The charging reservation and the guidance of the charging station are performed by establishing the two-way communication between the vehicle and the charging station (S260). In detail, the two-way communication is established between the vehicle terminal, for example, the telematics unit and the power capacity controller of the charging station, the vehicle terminal reserves the charging, and the power capacity controller may perform location guidance, price information guidance, etc. in order to allow the vehicles to reach the charging stations.

Meanwhile, when the power amount held by the charging station is not enough to charge the battery of the vehicle, the power center server supplies power to the charging stations (S270).

In detail, when the power center server determines whether the power amount held by the charging station is enough to charge the battery of the vehicle, the power center server may previously supply power to the corresponding charging station. Alternatively, when the charging station determines whether the holding power amount is enough to charge the battery of the vehicle, the charging station requests the required amount of power to the power center server and the power center server may supply power the requested power demand to the corresponding charging station.

After the charging station is supplied with power, it determines whether the charging station can charge the battery (S280) and if so, it transmits the information on the location, standby time, and holding power amount to the vehicle terminal (S250). If it is determined that the charging station cannot charge the battery, the power center server informs the vehicle terminal of the information thereon and extends the POI area, thereby making it possible to previously supply power to other charging stations.

Examples of transmitting the information on the location of the vehicle to the power center server will be described below.

First, solutions supported by a mobile communication network will be described.

The mobile communication network periodically performs a location information update procedure that updates the present location of the terminal to a mobile communication network server for mobile management and stores and maintains the location information the terminal in a mobility management entity (MME), a home location register (HLR), or a home subscriber server (HSS) of the network, based on the location information update procedure. The location information stored in the MME, the HLR, and the HSS, etc., may be a level corresponding to information on an eNodeB in which the terminal is located. The location information update procedure is a basic procedure of the mobile communication network, not a procedure triggered by applications.

When considering general mobility management ability of the mobile communication network, there may be two methods as solutions that can be provided by a network resource.

First, a proactive location provision method will be described.

Network nodes such as the MME/HLR/HSS, etc., of the mobile communication network may provide the information on the location of the terminal to the power center server whenever the terminal location of the vehicle is changed. In this case, when an event for the battery state is generated, for example, when the battery is smaller than the threshold value, the information on the battery is transmitted from the vehicle terminal to the power center server and the power center sever uses the received information to previously prepare power in the charging system of the corresponding area. In this case, the power center server transmits the information on the reserved charging station to the terminal in the vehicle. That is, before the power center server receives the information on the battery, it frequently receives the information on the location regardless of whether it receives the information on the battery. The detailed contents of the exemplary embodiment of the present invention will be described with reference to FIGS. 4 to 7.

Second, a reactive location acquisition method will be described.

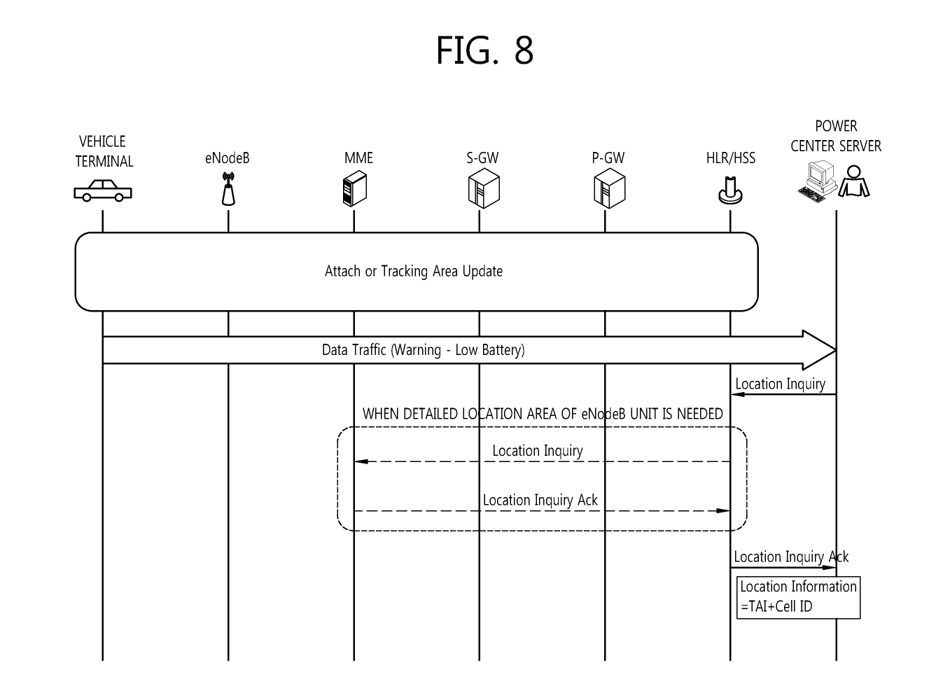

When the power center server receives the information on the battery from the vehicle terminal, it senses the information and then, requests the location information transmission to the network node that stores the location information of the terminal. The power center server receives the information on the location of the terminal as a response to the request. That is, the network nodes do not need to continuously transmit the location information of the terminal regardless of the state of the battery. Therefore, the power center server transmits the information on the reserved charging stations to the telematics unit of the vehicle while taking a measure in order to previously reserve power in the charging system in the vicinity of an area in which the vehicle is located based on the location information received from the network node. In this case, the power center server should search the network node storing the location information of the vehicle terminal and acquire the location information. The detailed method thereof will be described below with reference to FIG. 8.

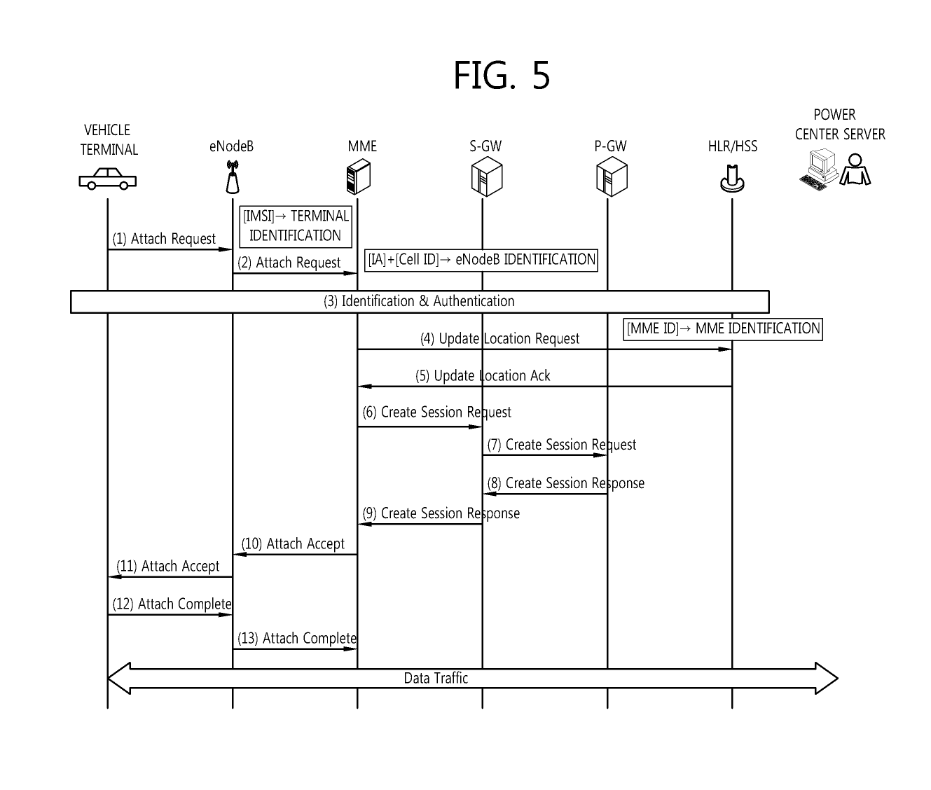

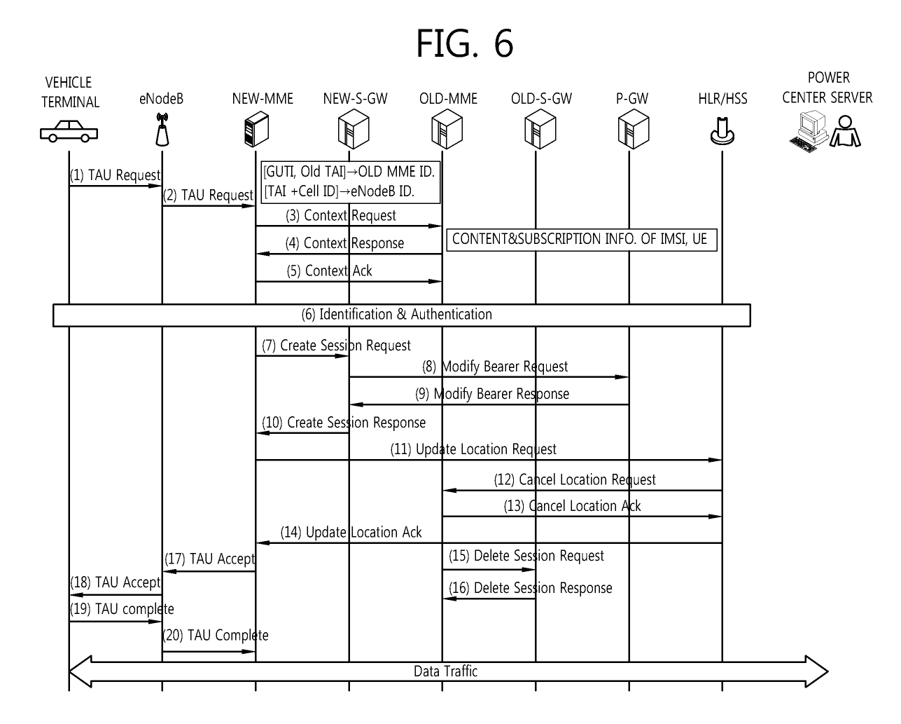

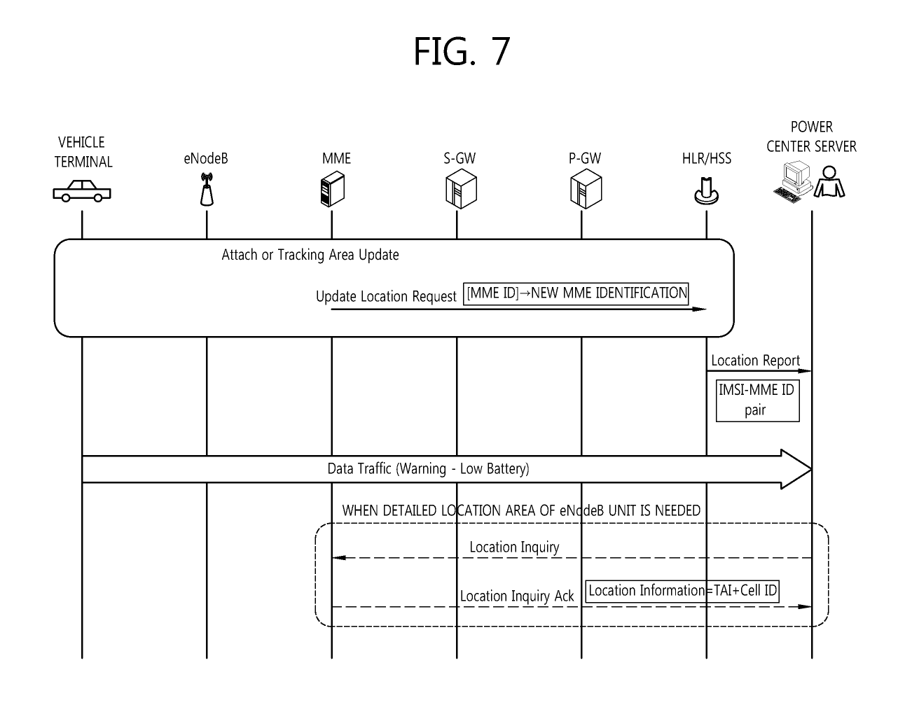

The proactive location provision method will be described in detail with reference to FIGS. 4 to 7. FIG. 4 is an exemplified diagram showing a 3GPP based mobile network architecture, FIG. 5 is a flow chart showing a procedure of attaching a vehicle terminal to a network, FIG. 6 is a flow chart showing a procedure of updating a tracking area, and FIG. 7 is a flow chart showing a procedure of transmitting information on the location of the vehicle to the power center server. The exemplary embodiment of the present invention corresponds to a mobile communication network support solution using a 3GPP LTE (Long Term Evolution) based mobile communication network.

The 3 GPP LTE based mobile network is configured to include network nodes such as the eNodeB, the MME, a serving GW (S-GW), a PDN GW (P-GW), the HLR/HSS, etc., as shown in FIG. 4.

In this case, it is assumed that the mobile network is connected with an external Internet network through the P-GW and the power center server is located at the external Internet network. It is assumed that the vehicle terminal accesses the mobile network through a cellular interface, like a general portable terminal.

The eNodeB provides a cellular wireless interface to the vehicle terminal and sets wireless bearer used for transmitting and receiving a signaling message and user data traffic and sets packet connection up to the mobile network nodes.

The MME provides functions such as the ID identification, position, and moving management of the terminal, authentication and security, S-GW sorting to be used to transmit traffic, etc., based on the signaling message received through the eNodeB from the vehicle terminal.

The P-GW performs a gateway function that connects the mobile network with the external Internet network.

There is a need to connect the terminal with the application servers of various external Internet networks according to applications performed in the terminal. In this case, the S-GW routes the packets up to the used P-GW to be connected with the application servers in the local network in which the terminal is currently located.

The HLR/HSS are a kind of central data base system that stores the subscription information and the location information of the mobile subscriber, etc.

The mobile network provides the mobile management function that locates and manages the position and state of the vehicle terminal of which the location is changed every hour.

As a representative procedure used for mobility management, there are an attach procedure accessing the network due to power-on of the terminal, etc., a tracking area update procedure used to report to the mobile network when the terminal enters a new tracking area (an area covered by one or more eNodeB) by the movement of the terminal, or the like.

FIG. 5 shows a main signal flow of the attach procedure.

When the attach procedure starts by the power-on the terminal, the terminal transmits the attach request message to the eNodeB. The attach request message includes the inherent ID or temporary ID of the terminal, such that the ID based eNodeB may identify the terminal that wants to access the network.

The eNodeB receiving the attach request transmits the message to the MME. In this case, the eNodeB includes the tracking area identifier (hereinafter, referred to as TAI) of the area that is covered by the eNodeB and a cell identifier inherently allocated to each eNodeB.

The MME receiving the attach request message can identify which tracking area the terminal accessing the network through the MME is located and what eNodeB currently accesses.

After the MME receives the attach request message, it transmits the update location request message in order to inform the fact that the terminal accesses the network through the HLR/HSS and the position of the terminal. The message includes the ID information of the transmitting MME.

Therefore, the HLR/HSS receiving the update location request message identifies the MME of the area in which the present terminal is located, based on the ID of the MME.

Thereafter, in order to transmit the user data traffic, when a packet session is set between the eNodeB and the S-GW and the P-GW, an attach accept message is finally transmitted to the terminal and then, the user data can be transmitted and received.

The tracking area update procedure starts when the terminal accessing the network moves to other tracking areas without performing a separate service or periodically according to a predetermined time. FIG. 6 shows a main signal flow of the tracking area update procedure.

When the terminal senses that the terminal enters the new tracking area based on system information broadcast in the network, the terminal transmits the tracking area update request (hereinafter, referred to as TAU request) message to the eNodeB. The TAU request message includes the TAI of the terminal and generally unique temporary ID (GUTI) information previously allocated by the MME.

The eNodeB receiving the TAU request message transmits the TAU request message to the MME, and in this case, includes the TAI of the area covered by the eNodeB and the cell ID inherently allocated to each eNodeB, in addition to the GUTI and the previous TAI information.

The MME receiving the TAU request message differentiates whether the GUTI is allocated to the MME using the GUTI information. If it is determined that the GUTI is not allocated to the MME, the MME acquires the previous MME (OLD-MME) information allocating the GUTI using the GUTI and transmits a context request message requesting all information (subscription and context information) of the terminal to the previous MME (OLD-MME).

A new MME (NEW-MME) performs a procedure of resetting the packet session between the eNodeB and the S-GW and the P-GW in order to transmit the user data traffic, based on the ID information and the context information such as inherent international mobile station identity (hereinafter, referred to as IMSI) of the terminal included in a context response message received from the previous MME (OLD-MME). In this case, the new MME (NEW-MME) implies an MME serving the new tracking area according to the movement of the terminal and the previous MME (OLD-MME) implies an MME serving the tracking area in which the terminal is located before movement.

When the packet session is reset and the MME serving the terminal is changed, the MME transmits the update location request message to the HLR/HSS in order to inform that the terminal enters in the new tracking area, wherein the message includes the ID information of the transmitting MME.

Therefore, the HLR/HSS receiving the update location request message identifies the new MME of the area in which the present terminal is located, based on the ID of the MME.

In other words, as shown in FIGS. 5 and 6, the HLR/HSS may identify the MME that serves the present terminal by the attach request and tracking area update procedure of the terminal and the MME may acquire the TAI in which the current terminal is located and the cell identifier of the eNodeB.

Therefore, the proactive location provision may be practiced by the following method shown in FIG. 7.

In other words, as shown in FIG. 7, the case where the tracking area in which the terminal is located is changed and thus, the MME serving the terminal is changed is informed to the HLR/HSS from the MME. Therefore, when the HLR/HSS receives the update location request message and confirms that the previous MME (OLD-MME) and the new MME (NEW-MME) of the terminal are different from each other, the HLR/HSS transmits the location report message to the power center server in order to inform this to the power center server.

Through this, the power center server can identify the MME that serves the terminal in real time regardless of the battery state of the vehicle and thus, identify the position of the terminal. Thereafter, when the power center server receives the information on the battery informing that the residual amount of the battery is reduced to the reference value or less from the terminal, it may previously distribute power to the charging stations in the area covered by the corresponding MME.

Since a single MME may cover the cell covered by several eNodeBs, the power center server may use the MME ID received from the HLR/HSS to request the TAI that is the eNodeB area in which the current vehicle terminal is located and the cell identifier to the corresponding MME when the cell information in the more detailed eNodeB unit is needed. To this end, the power center server may transmit a location inquiry message.

Next, the reactive location acquisition method will be described in detail with reference to FIG. 8. FIG. 8 is a flow chart showing another procedure of transmitting information on the position of the vehicle to the power center server.

Since the method according to the above-mentioned exemplary embodiments may cause the unnecessary signaling traffic between the HLR/HSS and the power center server, when the exemplary embodiment of the present invention receives the information on the battery informing that the residual amount of the battery is reduced to the reference value or less from the terminal, it may acquire the position of the vehicle terminal.

In the exemplary embodiment of the present invention, it is assumed that the power center server may induce the HLR/HSS storing and managing the location information of the terminal based on the information received from the terminal.

The power center server transmits the location inquiry message for acquiring the location information to the HLR/HSS storing the information of the corresponding terminal.

Similar to the above-mentioned exemplary embodiments, since the single MME may cover the cell covered by several eNodeBs, the HLR/HSS receiving the location inquiry message routes the location inquiry message to the MME storing the detailed location information of the present terminal when the cell information of the more detailed eNodeB unit is needed.

The location inquiry ACK message including the TAI that is the eNodeB area in which the vehicle terminal is located and the cell identifier transmitted from the MME is finally transmitted to the power center server, such that power may be previously distributed to the charging system in the area in the vicinity of the corresponding MME or the eNodeB.

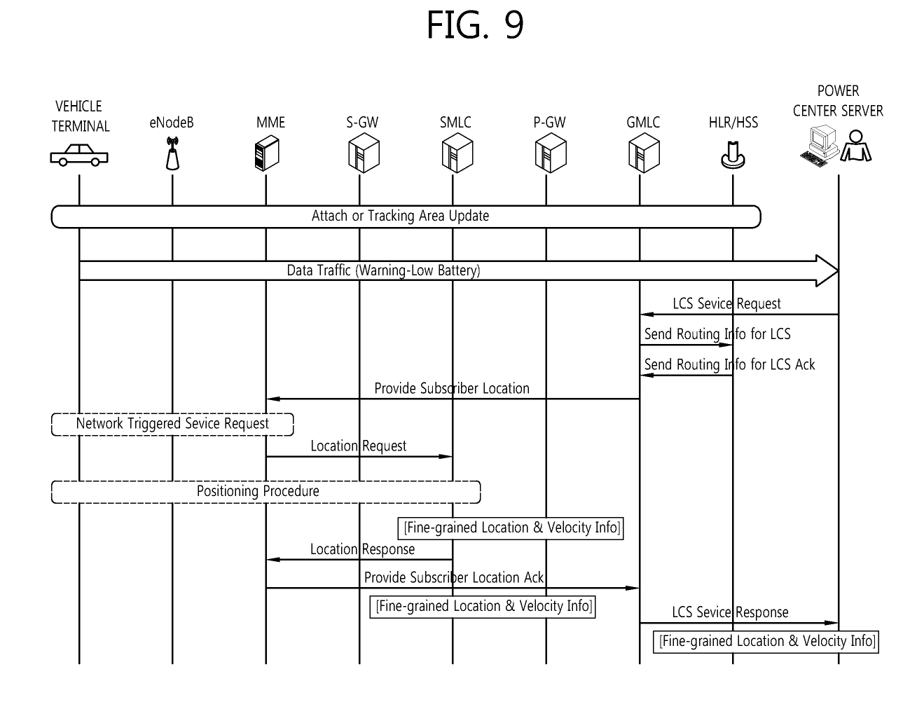

The above-mentioned exemplary embodiments assumes the case where the function for location service of the mobile network is not provided and may use the LCS function in the case where there are the network nodes providing the LCS function in the mobile network. The exemplary embodiment providing the LCS function will be described below with reference to FIG. 9.

FIG. 9 is a flow chart for describing a power supply control method and a power system according to another exemplary embodiment of the present invention.

FIG. 9 shows a process where the power center server uses the LCS function to acquire the position of the vehicle terminal.

For the LCS, a mobile location center (MLC), etc., may be present in the mobile network. The MLC may provide fine-grained location information and speed of the mobile terminal by using several positioning methods.

The MLC may be classified into a gateway MLC (hereinafter, referred to as GMLC) located in the home network of the terminal according to the position of the MLC to serve as the gateway and a serving MLC (hereinafter, referred to as SMLC) directly providing the location information through the positioning procedure with the terminal, etc.

As shown in FIG. 9, when the power center server is informed of the fact that the residual amount of the battery is reduced to the reference value or less from the vehicle terminal, it transmits the LCS service request message to the GMLC in order to acquire the information such the current location and speed of the vehicle terminal, etc.

When the GMLC does not know the information of the MME in which the present terminal is located, it transmits a send routing info for LCS message to the HLR/HSS and acquires the information of the MME through the ACK message from the HLR/HSS.

The GMLC uses the acquired MME information to transmit a provide subscriber location message in order to request the location information of the terminal to the MME in which the present terminal is located.

When the terminal does not access the network, the MME receiving the provide subscriber location message performs a network triggered service request procedure including paging, etc., for accessing the terminal.

Thereafter, when the terminal accesses the network, the MME transmits the location request message to the SMLC that can perform the positioning procedure with the terminal.

The SMLC receiving the location request message uses various positioning methods to measure the detailed location and speed information of the terminal and report the measured detailed information and speed information to the MME through the location response message.

The MME receiving the location response message transmits the provide subscriber location ACK message including the detailed position and speed information of the terminal to the GMLC and the GMLC finally transmits the provide subscriber location ACK message to the power center server through the LCS service response message. The power center server receiving the provide subscriber location ACK message may distribute power to the charging stations in the vicinity of the area in which the vehicle terminal is located.

Unlike the above-mentioned exemplary embodiments, the power center server may find the location of the vehicle using different methods. For example, the power center server may find the location of the vehicle through the solutions of the application layer.

If it is assumed that the mobile communication network provides only the transport function for transmitting the user data between the vehicle terminal and the power center server, the terminal can locate its own present position in real time by using the GPS function of the telematics unit such as navigation installed in the vehicle, etc. Therefore, when the terminal determines the current state of the battery and when the charging of the battery is needed, the data connection path to the power center server is set through the wireless communication networks (3 G, 4 G, WiFi, WAVE, DSRC, etc.) and the battery state report together with the GPS location information may be transmitted in the user data type.

In the case of the above-mentioned mobile communication network support solution, even when the GPS receiver is not provided in the vehicle terminal or is not operated, the terminal can perform the corresponding functions only if it has the function of accessing the mobile communication network. The application layer solution has an advantage in that the GPS receiver is required in the terminal and the transmission function can be performed through various wireless communication networks including the mobile communication network, in order to transmit the location information.

As set forth above, the exemplary embodiment of the present invention adjusts the demand and supply of power according to the appearance of the electric automobile having mobility in real time using the mobile management function of the telematics system and the mobile communication network, thereby making it possible to control and distribute power generated for each process at the power system in real time. The exemplary embodiment of the present invention relieves the concerns and risk of the battery discharge for the long distance driving in view of the user using the electric automobile, thereby making it possible to promote the propagation of the electric automobile and efficiently build the smart grid.

Although the configuration of the present invention has been described in detail with reference to the exemplary embodiments and the accompanying drawings, it is only an example and may be variously modified in the scope of the present invention without departing from the spirit of the present invention. Therefore, the scope of the present invention should be not construed as being limited to the described exemplary embodiments but be defined by the appended claims as well as equivalents thereto.

What is claimed is:

1. A power supply control method by a power center server, the power supply control method comprising:
receiving information on a location and a battery of a vehicle; and
supplying power to charging stations in the predetermined range of the location of the vehicle to be able to charge the battery of the vehicle based on the information on the location and the battery

2. The power supply control method of claim 1, wherein the supplying power includes:
querying power amount held by charging stations in the predetermined range of the location of the vehicle based on the information on the location; and
supplying power to the charging stations determined that the holding power amount is smaller than power amount to be able to charge the battery based on the information on the battery.

3. The power supply control method of claim 1, wherein the supplying power includes:
providing the information on the location of the vehicle and the battery to the charging stations in the predetermined range of the location of the vehicle; and
supplying power demand requested based on the information on the battery to the charging station.

4. The power supply control method of claim 1, further comprising transmitting at least one of location information, estimated standby time, and charging price information of the charging stations performing the charging in the predetermined range of the location of the vehicle and power amount held by the charging station to the vehicle.

5. The power supply control method of claim 1, wherein the receiving includes:
receiving the information on the location of the vehicle from a mobility management entity (MME), a home location register (HLR), or a home subscriber server (HSS) of a mobile communication network storing the location of the terminal installed in the vehicle whenever the location of the vehicle is changed; and
receiving the information on the battery from the vehicle terminal when an event that the power residual amount of the battery is a reference value or less is generated.

6. The power supply control method of claim 5, wherein the HLR or the HSS confirms that the current MME is different from a previous MME previously performing the location information update request by receiving a location information update request of the terminal from a current MME to transmit an identifier of the current MME and the receiving of the information on the location of the vehicle includes receiving the identifier of the current MME from the HLR or the HSS.

7. The power supply control method of claim 6, wherein the receiving of the information on the location of the vehicle includes:
requesting information on a tracking area that is an eNodeB area in which the current vehicle is located and a cell to the current MME, based on the received MME identifier; and
receiving the information on the tracking area and the cell from the current MME.

8. The power supply control method of claim 1, wherein the receiving includes:
receiving the information on the battery transmitted by the vehicle terminal when an event that the power residual amount of the battery is the reference value or less is generated; and
requesting the information on the location of the terminal to the mobility management entity (MME), the home location register (HLR), or the home subscriber server (HSS) of the mobile communication network storing the location of the terminal and receiving the information on the location as a response to the request, when the information on the battery is received.

9. The power supply control method of claim 8, wherein the receiving of the information on the location includes:
requesting the information on the location of the terminal to the HLR or the HSS; and
receiving the information on the tracking area that is the eNodeB area in which the current vehicle is located and the cell from the HLR or the HSS, the information on the tracking area and the cell being acquired by requesting the HLR or the HSS to the MME.

10. The power supply control method of claim 1, wherein the receiving includes:
receiving the information on the battery transmitted by the vehicle terminal when the event that the power residual amount of the battery is the reference value or less is generated; and
requesting the information on the location of the terminal to a gateway mobile location center (GMLC) and receiving the information on the location as the response to the request, when the information on the battery is received.

11. The power supply control method of claim 1, wherein the receiving includes receiving at least one of an identifier of the vehicle, the information on the location of the vehicle, the power residual amount of the battery, battery temperature, rated voltage of the battery, and final charging time from the vehicle terminal.

12. A power management method by a charging station server, the power management method comprising:
getting a supply of power from a power center according to holding power amount and a battery state of a vehicle; and
transmitting at least one of location information, estimated standby time, charging price information of the charging station and power amount held by the charging station to the vehicle.

13. The power management method of claim 12, further comprising:
providing a reserved request for charging from the vehicle; and
providing point of interest (POI) information of the charging stations to the vehicle.

14. The power management method of claim 12, further comprising:
receiving information on the location and battery of the vehicle;
determining whether power amount held by the charging station is able to charge the battery based on the information on the location and the battery; and
requesting the supply of power to the power center as the determination result.

15. The power management method of claim 13, further comprising informing the power center of the holding power amount according to the query of the power center.

16. A power system, comprising:
a vehicle terminal transmitting information on a battery; and
a power center server supplying power to charging stations in the predetermined range of the location of the vehicle to be able to charge the battery of the vehicle based on information on the battery and information on the location of the vehicle terminal.

17. The power system of claim 16, wherein the vehicle terminal monitors the battery and transmits the information on the battery and the information on the location to the power center server when an event that a power residual amount of the battery is a reference value or less is generated and
receives at least one of the location information, estimated standby time, charging price information of the charging station and the power amount held by the charging station.

18. The power system of claim 17, wherein the vehicle terminal locates the location of the vehicle terminal through a global positioning system (GPS) and transmits the information on the battery and the information on the location to the power center server in any one communication manner of third generation communication, fourth generation communication, WiFi, WAVE communication, and DSRC(D) when the event is generated.

19. The power system of claim 16, wherein the power center server receives the information on the location of the vehicle from a mobility management entity (MME), a home location register (HLR), or a home subscriber server (HSS) of a mobile communication network storing the location of the terminal installed in the vehicle whenever the location of the vehicle is changed and
receives the information on the battery from the vehicle terminal when the event that the power residual amount of the battery is the reference value or less is generated.

20. The power system of claim 16, wherein the power center server receives the information on the battery transmitted by the vehicle terminal when the event that the power residual amount of the battery is the reference value or less is generated to request the information on the location of the terminal to the mobility management entity (MME), the home location register (HLR), the home subscriber server (HSS), or the gateway mobile location center (GMLC) and receives the information on the location as the response to the request.
